(19) United States
(12) Patent Application Publication
(10) Pub. No.: US 2023/0342195 A1
(43) Pub. Date: Oct. 26, 2023

(54) WORKLOAD SCHEDULING ON COMPUTING RESOURCES

(71) Applicant: Altair Engineering, Inc., Troy, MI (US)

(72) Inventor: Friedrich Franz Xaver Ferstl, Maxhuette-Haidhof (DE)

(21) Appl. No.: 18/173,982

(22) Filed: Feb. 24, 2023

Related U.S. Application Data
(60) Provisional application No. 63/367,393, filed on Jun. 30, 2022.
(60) Provisional application No. 63/363,335, filed on Apr. 21, 2022.

(51) Int. Cl. G06F 9/48; G06F 9/54

(52) U.S. Cl. CPC G06F 9/4881; G06F 9/54

(57) ABSTRACT

Methods, systems, and apparatus, including medium-encoded computer program products in which a first computing engine obtains a descriptor for a unit of work to be executed on a workload processing system. The first computing engine can manage the workload processing system that can include two or more workload processors, and a first workload processor of the workload processing system can be managed by a second computing engine. The first computing engine can assign the descriptor to a workload based at least in part on a resource requirement fingerprint that characterizes the unit of work. The second computing engine can select the descriptor from the workload category based at least in part on: (i) the resource requirement fingerprint of the descriptor, and (ii) available resources within the first workload processor. The second computing engine can cause the first workload processor to execute the unit of work.

### BACKGROUND

This specification relates to assigning computing workloads to computing resources. Resources can include processing resources such as central processing units (CPUs), memory, storage capacity, network bandwidth, graphics processing units (GPUs), application specific integrated circuits (ASICs), and field programmable gate arrays (FPGAs), among others, software resources such as software licenses, and user-defined resource types, among other types of resource.

### SUMMARY

This specification describes technologies relating to assigning workloads to workload processors. The assignment can occur in two-stages: a workload processing manager system can assign workloads to categories, and cluster managers can select workloads from the categories for processing by the workload processors. The workload processing manager can assign workloads to categories iteratively, where a workload is assigned to a first, more general category, then assigned to a second, more-specific category. A cluster manager can make selections to encourage efficient use of a workload processor's resources and to ensure that the workload processor contains the type and number of resources required to execute the workload efficiently.

Particular embodiments of the subject matter described in this specification can be implemented so as to realize one or more of the following advantages. The techniques described below can be used to efficiently schedule the resources of a workload processing system by first assigning workloads to categories based on “fingerprints” (e.g., characteristics) of the workloads, then allowing cluster managers to select workloads from categories based on the fingerprints and on available resources. This two-stage scheduling promotes efficient resource use. In addition, both phases of the scheduling can use rules and/or policies when assigning and selecting the workloads, which provides system flexibility and scalability in the assignment process as rules and/or policies can be added and/or deleted based on the requirements of the system. Further, the techniques can be used to assign priorities to workloads, enabling priority-based scheduling. Priority-based scheduling can be used to support resource allocation based on quota even when demand differs among workloads and to ensure efficient use of sparse resources (e.g., the amount of resource is limited as compared to demand for the resource), among other benefits. In addition, since the first phase can iteratively assign workloads to categories, the system can use parallel processing and/or multi-threading to improve processing efficiency and scalability. Further, the techniques can be used to schedule large jobs on the system without imposing unacceptable delays in scheduling such jobs.

One aspect features a first computing engine obtaining a descriptor for a unit of work to be executed on a workload processing system. The first computing engine can manage the workload processing system that can include two or more workload processors, and a first workload processor of the workload processing system can be managed by a second computing engine. The first computing engine can assign the descriptor to a workload category of a plurality of workload categories based at least in part on a resource requirement fingerprint that characterizes the unit of work. The second computing engine can select the descriptor from the workload category based at least in part on: (i) the resource requirement fingerprint of the descriptor, and (ii) available resources within the first workload processor. The second computing engine can determine the unit of work associated with the descriptor and cause the first workload processor to execute the unit of work.

One or more of the following features can be included. The first workload processor can execute the unit of work. Assigning the descriptor to a workload category can include determining a first workload policy relevant to the unit of work, evaluating the first workload policy to produce a first policy result, and assigning the descriptor associated with the unit of work to a workload category of a plurality of workload categories based at least in part on the first policy result. Assign the descriptor to a workload category can include evaluating a second workload policy to produce a second policy result, and assigning the descriptor associated with the unit of work to a workload category of a plurality of workload categories based at least in part on the first policy result and the second policy result. The first computing engine can determine descriptors assigned to the workload category and determine that a descriptor in the descriptors is associated with a unit of work that is not ready to execute. The first computing engine can assign the descriptor to a workload category that stores descriptors associated with units of work that are not ready to execute. The resource requirement fingerprint can include one or more of the number of CPUs needed, memory requirement, storage requirement, the number of GPUs needed or network bandwidth. A second workload processor of the workload processing system can be managed by a third computing engine, and the second computing engine can differ from the third computing engine. Assigning the descriptor to a workload category can include processing an input that includes features that include at least a subset of values in the descriptor using a machine learning model that is configured to generate category predictions, and assigning the descriptor to a workload category of a plurality of workload categories based at least in part on a category prediction of the category predictions.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of an environment for liquid workload scheduling.

FIG. 2 shows a process for liquid workload scheduling.

FIG. 3 shows a process for iteratively applying policies to workload descriptors.

FIG. 4 is a block diagram of an example computer system.

FIG. 5A shows a process for scheduling jobs that meet specified criteria.

FIG. 5B shows an example workload descriptor.

FIG. 6 shows a process for assigning priority.

FIG. 7A shows an example workload processing system that includes a workload processing manager system.

FIG. 7B shows an example of a workload processing manager system 790 with embedded workload processing manager systems.

FIG. 8 shows a process for liquid workload scheduling within a workload processing system.

FIG. 9 shows an example hierarchical collection of workload categories.

Like reference numbers and designations in the various drawings indicate like elements.

### DETAILED DESCRIPTION

Clusters of computing resources provide a scalable and efficient platform for executing workloads, and therefore have become increasingly prevalent, including in Cloud deployments. Resources included in a cluster can include both general-purpose computing resources, such as CPUs, memory, storage capacity, and network bandwidth, and special-purpose resources such as GPUs, ASICs, reconfigurable processors (e.g., FPGAs), and so on.

The resources in a cluster can be managed by a subsystem that determines how resources are assigned to computing jobs. Such “cluster managers” can provide computing elasticity: they can assign smaller jobs a small subset of the resources and larger jobs more resources. In addition, a cluster manager can assign special-purpose resources to jobs that have particular needs. For example, a cluster manager can assign a set of GPUs to jobs that most benefit from such a resource, such as a graphics-intensive application or a cryptocurrency mining application. The assignment of computing jobs, also called “workloads,” to computing resources is called “workload management.”

A central cluster manager can perform workload management for a cluster. Such a cluster manager can evaluate workloads as they arrive, determine available resources, and assign resources to workloads. However, such systems can be inflexible: once the workload assignment strategies are set, adjustment is difficult. In addition, a single scheduler can become a bottleneck as the demands on the system increase. For example, it is now common for data centers to include tens or hundreds of thousands of computing system, each of which can receive thousands of requests per second, and data center scale continuously increases. A central cluster manager can limit the capacity of the overall system, and this challenge will increase over time.

Instead, the workload management techniques of this specification include a two-stage, “liquid,” approach. In the first stage, a workload descriptor assignment engine (or “system manager,” for brevity) evaluates arriving jobs to determine a “fingerprint” of the job based on the job's computing requirements, then assigns the job to a particular workload category based on the fingerprint and assignment policies. Further, the first stage can assign workloads to categories iteratively, as described further below. In the second stage, cluster manager engine (or “cluster manager,” for brevity) associated with a cluster of resources “pulls” a selected a job from a workload category and assigns the job to resources managed by the cluster manager. A cluster manager is free to select jobs that best meet the available capacity of its cluster resources. Thus, rather than have a central cluster manager that “pushes” workload through the system, the workload flows naturally through the system from system manager to cluster managers to cluster resources.

Although the description herein refers to the assignment of workloads to one or more clusters, this is merely an illustrative example. In practice, the described workload management techniques can be used to assign workloads to any type and/or grouping of computing resources across any number of physical devices. As an example, the described workload management techniques can be used to assign workloads to workload processors in a single computer device, workload processors distributed across several computer devices (e.g., one or more computing clusters and/or cloud computing environments), or any combination thereof. As another example, the described workload management techniques can be used to assign workloads to specific types of computing resources, such as specific instances of CPUs, memory, storage devices, GPUs, ASICs, FPGAs, etc., or any combinations thereof.

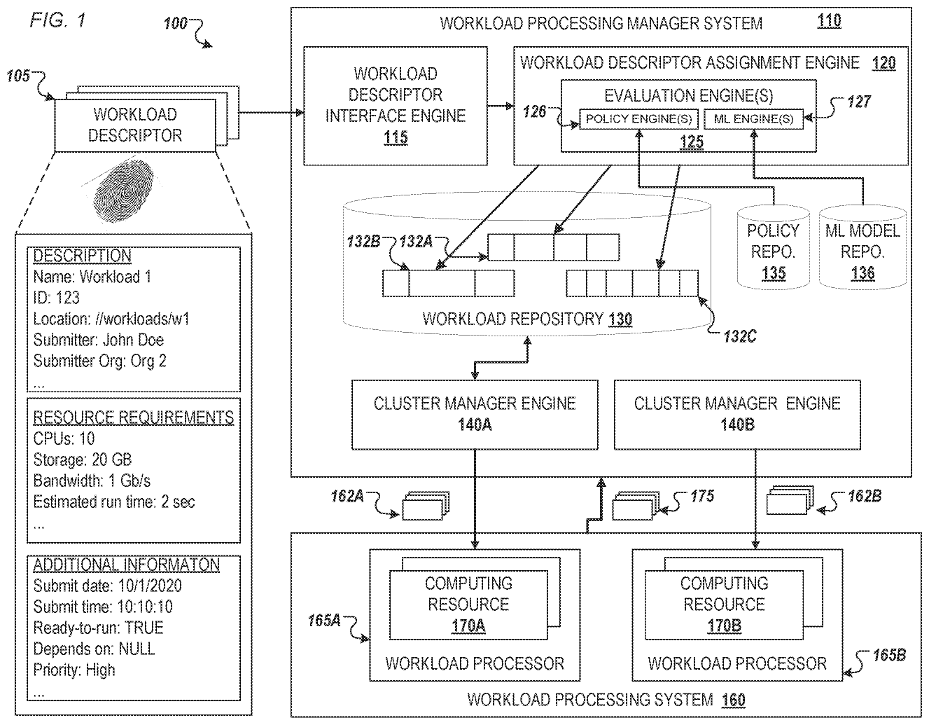

FIG. 1 shows an example of an environment 100 for liquid workload scheduling. The environment 100 can include a workload processing manager system 110 and a workload processing system 160.

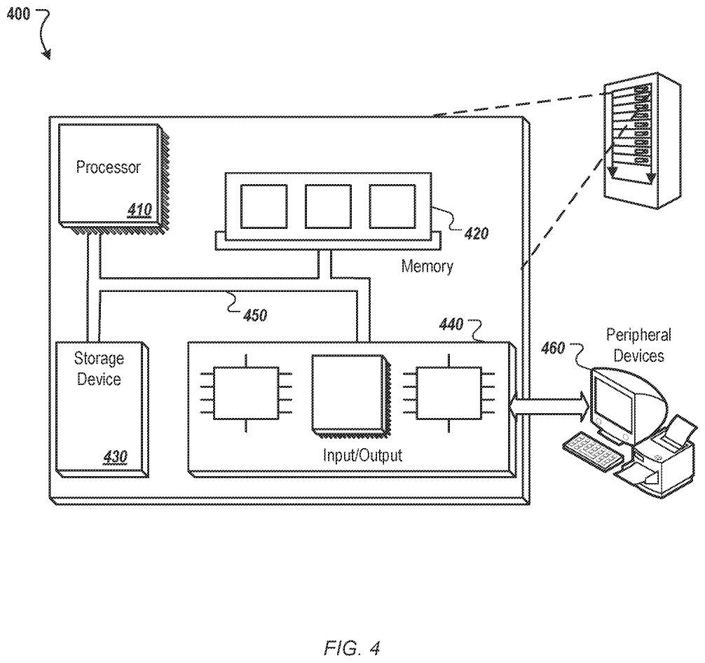

The workload processing manager system 110 can be a computing engine and can include a workload descriptor interface engine 115, a workload descriptor assignment engine 120, one or more workload repositories 130, a policy repository 135, a machine learning model repository 136 and cluster manager engines 140A, 140B (collectively referred to as 140). The workload processing manager system 110, the workload descriptor interface engine 115, the workload descriptor assignment engine 120, and the cluster manager engines 140 can be a computing engine and can be implemented using one or more computer systems (e.g., the computer system 400 of FIG. 4). For example, each engine and each system can be implemented on a single computer system or on multiple computer systems such as a Cloud computing environment hosted in one or more data centers. In addition, in some implementations, the workload processing manager system 110 and/or the workload processing system 160 can perform some or all of the described operations without direct human input or intervention.

The workload descriptor interface engine 115 can accept workload descriptors 105. Workload descriptors 105 describe jobs that have been submitted for execution to the workload processing system 160 and serve as the “fingerprints” for the jobs. The workload descriptor 105 can include descriptive information about the workload, resource requirements and additional information relevant to the workload. The descriptive information can include the name of the workload, an identifier (which can be unique), the location (or locations) of the executable(s) that are to be run, the submitter, the submitter's organization, an approver who authorized the job, the job priority, and so on.

The resource requirements can include a description of the resources that will be used by the workload, and can include a description of the requirements for each of one or more of the resource types (e.g., a job might require ten CPUs, twenty gigabytes of storage, etc.) The resource requirements can also specify range for one or more resource types. For example, they can specify that the workload requires a minimum of five CPUs, and can use up to ten CPUs. In some implementations, if only a single value is specified (e.g., ten CPUs), that value is interpreted as the minimum requirement.

Various additional information fields can also be included. For example, such information can include the job submission time (e.g., date, time of day), whether the job is ready to run, other jobs on which this job depends (e.g., a job that must be completed before the job associated with this descriptor can be executed), the location the job was submitted, the type of device used to submit the job, and so on.

The workload descriptor interface engine 115 can accept workload descriptors 105 using any conventional data transmission technique. For example, the workload descriptor interface engine 115 can provide an application programming interface (API) that can accept workload descriptors 105. The API can be, for example, a Web Server API that can be called both from local and remote devices. In some implementations, users can add workload descriptors 105 to a file or to a database, and the workload descriptor interface engine 115 can read the workload descriptors 105. In some implementations, the workload descriptor interface engine 115 can accept workload descriptors 105 that are included in HyperText Transfer Protocol (HTTP) messages. In various implementations, these techniques can be used in any combination, and other suitable techniques can be used.

The workload descriptor assignment engine 120 can obtain workload descriptors 105 from the workload descriptor interface engine 115 and assign the workload descriptors 105 to a workload category 132A, 132B, 132C (collectively referred to as 132) within the workload repository 130.

In some implementations, the workload descriptor assignment engine 120 can evaluate workload descriptors 105 that have been assigned to workload categories 132. The workload descriptor assignment engine 120 can iteratively evaluate and reassign workload descriptors 105 from more general workload categories 132 to more specific workload categories 132 as described further below.

The workload repository 130 can be any convention storage repository. For example, the workload repository 130 can be an in-memory, append-only data structure (e.g., a Redis Stream), a structured or unstructured database, a file system, block storage, etc.

Workload categories 132 within the workload repository 130 can be any appropriate physical or logical grouping of the workload descriptors 105 stored in the workload categories 132. For example, a workload category 132 can be an array in which each array element is a workload descriptor 105 or a reference to a workload descriptor 105 assigned to the workload category 132. In another example, a workload category 132 can be a table in a relational database, and entries in the table can be workload descriptors 105 or references to workload descriptors 105. In still another example, a workload category 132 can be a hashtable in which each element is a workload descriptor 105 or a reference to a workload descriptor assigned to the workload category 132.

A workload category 132 can include category criteria, and workload descriptors 105 can be assigned to the workload category based on to the category criteria. Category criteria can describe properties of the workload descriptors 105 included in the category. For example, a category criterion might specify that assigned workload descriptors 105 require no more than five CPUs or that assigned workloads require one GPU. Another category criterion might specify that the workload category 132 contains high priority jobs. In some implementations, the category criteria are included in the workload categories 132, and in some implementations, workload categories 132 include references to category criteria.

In some implementations, a workload category 132 is defined by the fingerprints of the workload descriptors 105 assigned to it. For example, if a workload descriptor 105 includes two elements, CPU and storage, then the system can create a new category for every combination of CPU and storage values. In such implementations, categories are created dynamically as workload descriptors are encountered. For example, if a policy determines that all workload descriptors with a predicted execution time less than 100 milliseconds will be assigned to a first category and all other workload descriptors are assigned to a second category, then two categories will exist. If a second policy determines that all workload descriptors that require a GPU will be assigned to one category and all other workload descriptors are assigned to another category, then four categories will emerge. As additional policies are applied, still more categories can be created.

In some implementations, the workload descriptor assignment engine 120 includes one or more evaluation engines 125. In some implementations, the workload descriptor assignment engine 120 includes one or more policy evaluation engines 126 that evaluates policies to determine a target workload category 132. A policy can include a predicate and a target, where the predicate includes one or more conditions that relate to the assignment, and the target specifies a workload category 132. Predicates can depend various factors, which can include information included in the workload descriptors 105, information related workload categories, information related to the environment (e.g., current time, location of the workload processing manager system 100), and so on. If the policy evaluation engine 126 determines that a policy's predicate is satisfied for a particular workload descriptor 105, it assigns that workload descriptor 105 to the workload category 132 specified by the target. A policy can also include an order that can be used to determine the order in which policies are evaluated.

A policy can be specified in any appropriate policy description language. For example, a policy can be expressed in XML that contains elements specifying the predicate and target, as shown in Listing 1, below.

LISTING 1

```
<POLICIES>
<POLICY>
  <ORDER> 1 </ORDER>
  <PREDICATE>
  <CONDITION>
    <GPU-COUNT> 1 </GPU-COUNT>
  </CONDITION>
  <CONDITION>
    <PRIORITY> HIGH </PRIORTY>
  </CONDITION>
  </PREDICATE>
  <TARGET> CATEGORY_1 </TARGET>
</POLICY>
<POLICY>
      ...
</POLICY>
      ...
<POLICIES>
```

Predicates within a policy can also include Boolean operators that can apply to the condition. For example, a policy might specify a GPU count of at least one or a CPU count of at least eight. Any number of Boolean operators can be used and in any combination. For example, the system can specify “(Condition_A AND Condition_B) OR (Condition_C AND Condition_D),” and more complex Boolean expressions can be used.

The policy evaluation engine 126 can retrieve policies relevant to workload routing from a policy repository 135. The policy repository 135 can be any conventional data storage apparatus such as a relational database or a file residing in a file system. While the policy repository 135 is shown as being a component of the workload processing manager system 110, the policy repository 135 can also be stored on a remote computer and retrieved by the policy evaluation engine 126 using conventional techniques. For example, if the policy repository 135 is stored on a relational database (either local to the workload processing manager system 110 or on a remote server) the policy evaluation engine 126 can retrieve policies using Structured Query Language (SQL) calls.

In some implementations, the workload descriptor assignment engine 120 includes one or more machine learning (ML) model evaluation engines 127. The ML model evaluation engines 127 can be configured with one or more ML models that accepts as input features of a workload (e.g., one or more of fields of a workload descriptor), historical data describing the completion of workloads by workload processors (e.g., the workload processor, resources used, available capacity of the workload processor, time to completion, etc.), and produces a workload category that is predicted to characterize the workload. The machine learning model can be any appropriate type of machine learning model for multi-class classification such as decision trees, naive Bayes models, random forest models, multiclass perceptron neural networks, and Gradient Boosting.

The ML model evaluation engine 127 can retrieve one or more machine learning models relevant to workload routing from a ML model repository 136. The ML model repository 136 can be any conventional data storage apparatus such as a relational database or a file residing in a file system. While the ML model repository 136 is shown as being a component of the workload processing manager system 110, the ML model repository 136 can also be stored on a remote computer and retrieved by the ML model evaluation engine 127 using conventional techniques.

A cluster manager engine 140 obtains workload descriptors 105 from the workload category 132 within the workload repository 130, determines the workload 162A, 162B (collectively referred to as 162) associated with the workload descriptor 105, and provides the workload 162 to a workload processor 165A, 165B (collectively referred to as 165) within the workload processing system 160 managed by the cluster manager engine 140.

In some implementations, the cluster manager engines 140 can provide workload descriptors 105 to the workload processors 165, and the workload processors 165 can determine the workloads 162. Once workload 162 has been assigned to a workload processor 165, the cluster can use the resources 170A, 170B within the workload processor 165 to execute the workload. In some implementations, the workload processing manager system 110 includes one cluster manager engine 140 per workload processor 165. In some implementations, one workload processing manager system 110 can manage multiple clusters 165. For brevity, in this specification, a workload processor can be called a “cluster” as it will typically include multiple processing devices (e.g., computing servers), although the workload processor can contain only a single processing device.

The workload processing system 160 can include workload processors 165. Each workload processor 165 can include computing resources 170A, 170B (collectively referred to as 170). As described above, computing resources 170 can include processing devices, network attached storage, network bandwidth, software resources, and any other computing resource types. Processing devices can contain CPUs, memory, storage capacity, special-purpose resources such as GPUs, ASICs, reconfigurable processors (e.g., FPGAs), network adapters, and other components found in processing devices.

The workload processing system 160 can provide resource descriptors 175 to the workload processing manager system 110. A resource descriptor 175 can be expressed in any suitable data interchange format (e.g., Extensible Markup Language (XML)) and can include a listing of the resources available within the workload processing system 160. For example, a resource descriptor 175 for a server within a cluster can specify that the server contains two CPUs each with eight cores, one GPU, one terabyte of memory, etc., and that the server is assigned to a particular cluster. The resource descriptor can also include an element that indicates whether a resource descriptor 175 describes the resources included in the workload processor 165 or resources available at the time the resource descriptor 175 is sent. An example is shown in Listing 2, below.

LISTING 2

```
<RESOURCE-DESCRIPTOR>
  <RESOURCE-TYPE> SERVER </RESOURCE-TYPE>
  <DESCRIRTOR-TYPE> CONFIGURED </DESCRIPTOR-TYPE>
  <CLUSTER-ID> 12 </CLUSTER-ID>
  <CPU-COUNT> 2 </CPU-COUNT>
  <GPU-COUNT> 1 </GPU-COUNT>
    ...
</RESOURCE-DESCRIPTOR>
```

In the example of Listing 2, the “DESCRIPTOR-TYPE” element value (i.e., “CONFIGURED”) can indicate that the resources described in the resource descriptor 175 are the resources included in the cluster. In another example, the “DESCRIPTOR-TYPE” element value could be “AVAILABLE” (or a similar token), which can indicate that the descriptor is describing resources that are currently available in the cluster.

The workload processing system 160 can provide resources descriptors at various levels of granularity. For example, the workload processing system 160 can provide a single resource descriptor 175 that describes all resources present in the workload processing system 160, one descriptor 175 per workload processor 165 that describes all resources present in the workload processor 165, one descriptor 175 per resource in the workload processing system 160, and so on.

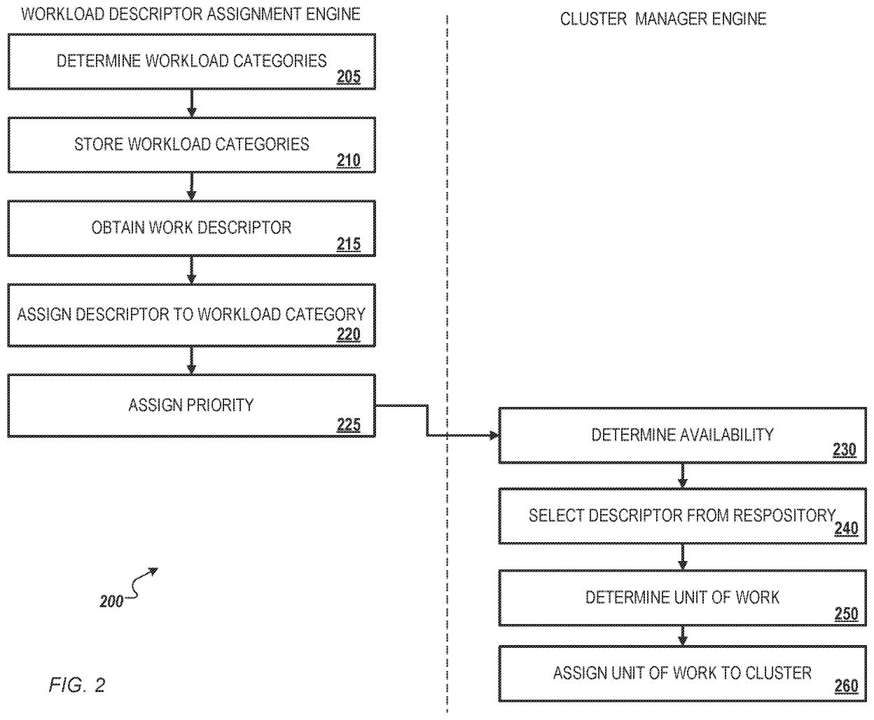

FIG. 2 shows a process for liquid workload scheduling. For convenience, the process 200 will be described as being performed by a workload processing manager system, e.g., the workload processing manager system 110 of FIG. 1, appropriately programmed to perform the process. Operations of the process 200 can also be implemented as instructions stored on one or more computer readable media, which may be non-transitory, and execution of the instructions by one or more data processing apparatus can cause the one or more data processing apparatus to perform the operations of the process 200. One or more other components described herein can perform the operations of the process 200.

The system determines (205) workload categories. In some implementations, the system can create workload categories dynamically based on characteristics of the workload descriptors. When the system encounters a workload descriptor that does not match an existing category, the system can create a workload category, as described further in reference to operation 220.

In some implementations, the system can create workload categories dynamically based on characteristics of the computing system such as resources available in the clusters. The system can receive one or more resource descriptors from a workload processing system, and use the resource descriptors to determine categories. The system can use the resource descriptors to determine capability differences among the clusters and use the capability differences to determine categories. For example, if only a subset of the clusters contain servers with GPUs, then the system can determine that categories depend on the presence of GPUs.

In some implementations, workload categories can be determined according to configured values. For example, a category can be configured for workloads with a particular characteristic such expected execution times of less than one hundred milliseconds, less than one second, less than five seconds and greater than five seconds. The system can assign the workload to the categories associated with the shortest execution time that is greater than the workload's expected execution time. In this example, the workload categories would have a category criterion specifying the ranges of expected execution times. Category criteria can be based on such characteristics and can be used to determine whether a workload can be assigned to the category. In some implementations, categories created dynamically are added to configured categories.

In another example, categories can be configured using category criteria that depend on multiple characteristics. For example, categories can be configured for workloads with expected execution times less than one second and that require a GPU, workloads with expected execution times less than one second and that do not require a GPU, workloads with expected execution times greater than one second and that require a GPU and workloads with expected execution times greater than one second and that do not require a GPU. The system can assign workloads to a category with category criteria that match the information provided in the workload descriptor, as described further below.

The system can retrieve the configured workload categories from a configuration repository using conventional data retrieval techniques. For example, the configuration repository can be a database, and the system can retrieve the configured workload categories using SQL.

The system stores (210) the workload categories. For each workload category created, the system can store the category, e.g., by writing it to a volatile or non-volatile storage media such as a disk drive. The system can also determine a reference to each category and add the reference to storage. For example, the workload categories can be added to a data structure such as an array, a list, a hashtable or other data structures suitable for storing references to the workload categories. Such a data structure can be stored within a workload repository.

The system obtains (215) a workload descriptor provided by a workload submitter. In some implementations, the system can provide a user interface through which the system can obtain workload descriptors. The system can create user interface presentation data (e.g., in HyperText Markup Language (HTML)) and provide the user interface presentation data to a client device. The client device can render the user interface presentation data causing the client device present a user interface to a user. By interacting with the user interface presentation data, a user can provide information included in a workload descriptor, and the user interface presentation data can cause the client device to create a workload descriptor and transmit the workload descriptor to the system. In some implementations, the user interface presentation data can cause the client device to transmit the data provided by the user, and the system can create a workload descriptor from the information provided.

In some implementations, the system obtains workload descriptors by providing an API through which workload submitter can submit workloads. For example, the system can include a Web Services API, which enables a workload submitter to provide a workload descriptor.

In some implementations, the system can retrieve workload descriptors from a repository. For example, workload submitters can add workload descriptors to a relational database, and the system can obtain workload descriptors from the database using SQL operations. In another example, workload submitters can add workload descriptors to a file (or to multiple files) in a file system, and the system can obtain the workload descriptors from the file system using convention file system read operations.

In some implementations, the system can retrieve a workload descriptor from a category to which the workload descriptor has been assigned. This technique enables the system to assign workloads to categories iteratively, as describe further below.

The system assigns (220) the workload descriptor to a workload category. In some implementations, the system can evaluate policies to determine the category for a workload descriptor. The system can retrieve the policies from a policy repository, for example, using SQL to retrieve policies from a relational database.

As described above, a policy can include a predicate and a target. In some implementations, the system can evaluate the policies according to an order that is specified by each policy. If an order is absent from the policies, or if two policies have the same order value, the system can determine the order of execution arbitrarily (e.g., at random or pseudo randomly).

When evaluating a policy, the system can evaluate the conditions in the policy's predicate to determine whether the predicate is satisfied. In some implementations, the system assigns the workload descriptor to the target of the first policy for which the predicate is satisfied. If no policy has a predicate that is satisfied, in some implementations, the system produces an error message. In some implementations, if no predicates are satisfied, the system can create a category a policy that that matches the workload description.

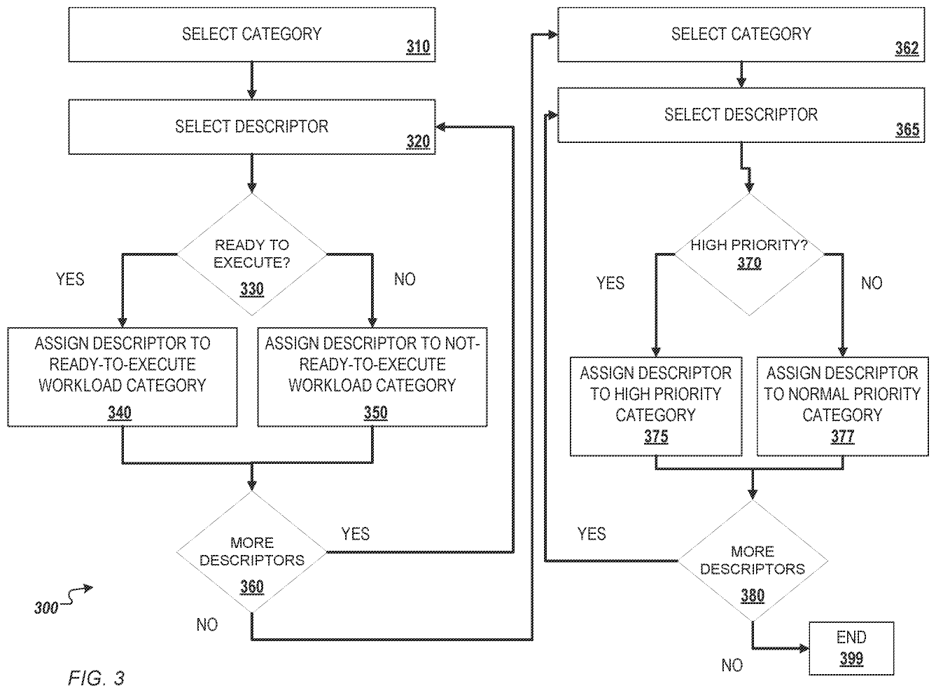

As described above, the system can assign workload descriptors to categories iteratively. When a workload descriptor arrives, the system can evaluate a first set of policies and based on the results, assign the workload descriptor to a first category. Once the workload descriptor has been assigned to a first category, the system can obtain the workload descriptor from the category, evaluate the workload descriptor against a second set of policies (which can be different from the first set of policies), and based on the result, assign the workload to a second category. This process can continue iteratively until all policy sets have been applied and the workload descriptor has been assigned to its final category. An example of this process is described in reference to FIG. 3.

In some implementations, the system can include a machine learning model that determines predictions that are used to assign workloads to categories. The system can process an input that includes as features all or part of the workload descriptor using a machine learning model that is configured to produce a prediction that indicates the best fitting category for the workload descriptor. In some implementations, the result of executing the machine learning model is a single predicted category. In some implementations, the result of executing the machine learning model is a set of predictions related to the workload categories. For example, the predictions can be, for each of one or more categories, the likelihood that the workload matches the category. In such cases, the system can select the category with the highest predicted value.

In some implementations, the system evaluates the workload requirements included in the workload descriptors against the category criteria associated with a category. In some implementations, the system can select a first category and compare the category criteria for the first category with the resource requirements specified by the workload descriptor. If the resource requirements satisfy the category criteria, the system can assign the workload descriptor to the category. If the resources requirements do not satisfy the category criteria, the system can select a second (different) category, and perform the same comparison. The system can continue this process until the criteria for a category are satisfied and the workload descriptor is assigned to the category or no categories remain. In the latter case, in some implementations, the system can produce an error message or provide an error value to the workload submitter. In some implementations, the system can create a new category with criteria that match the workload, as described above.

Once the system had determined a category, the system stores the workload descriptor in the workload repository according to the category. For example, if the workload repository is a FIFO data structure, the system can append the workload descriptor to the end of the FIFO. In another example, if the workload repository is stored in a relational database, the system can add the workload descriptor to the table containing descriptors of the selected category.

In some implementations, the system can employ techniques appropriate for large jobs, that is, jobs that have large resource requirements. Absent such techniques, the system can, in some circumstances, impose large delays on large jobs. For example, a job requiring multiple CPUs (e.g., 5, 10, etc.) might be delayed before it is scheduled since, when a smaller number of CPUs become free, the system can attempt to immediately schedule workloads on those CPUs, and the requisite number of CPUs might become available only after a long delay. However, if the job is sufficiently important, such delays are undesirable.

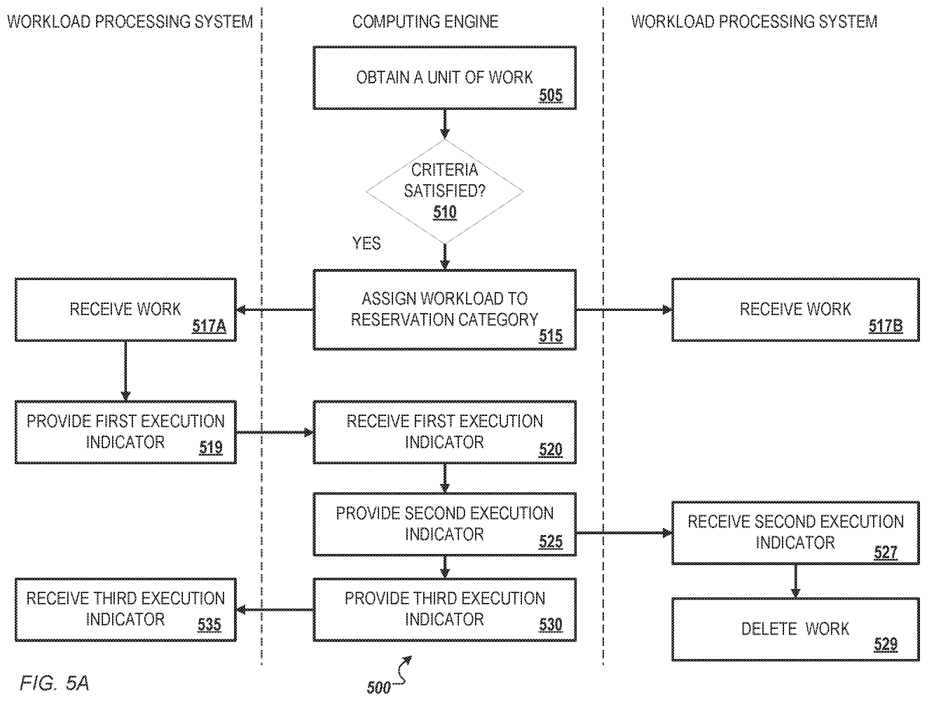

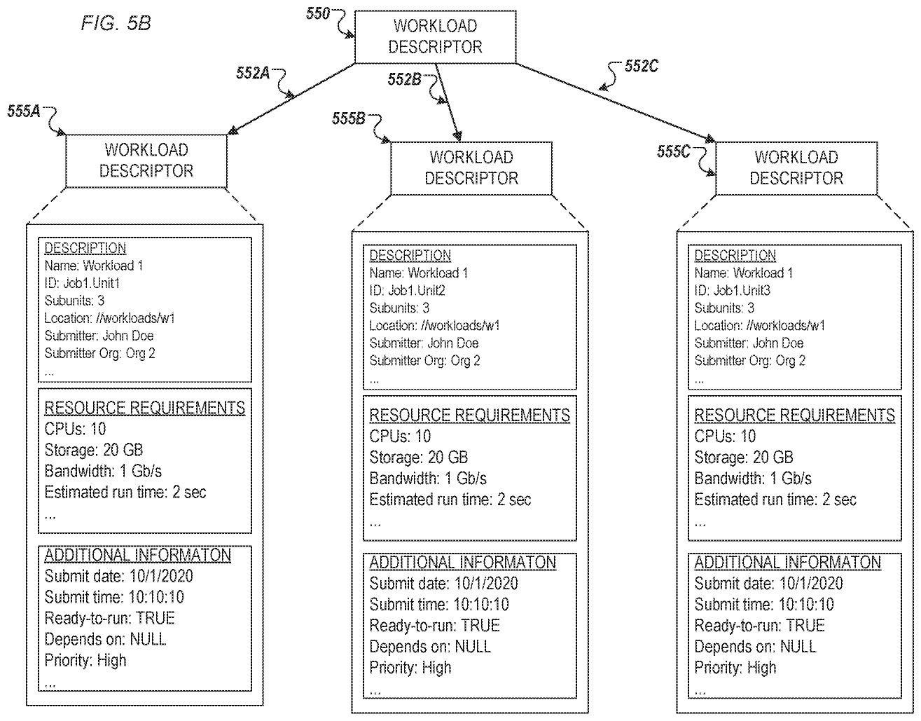

FIG. 5A shows a process for scheduling jobs that meet specified criteria. For convenience, the process 500 will be described as being performed by a workload processing manager system, e.g., the workload processing manager system 110 of FIG. 1, appropriately programmed to perform the process. Operations of the process 500 can also be implemented as instructions stored on one or more computer readable media, which may be non-transitory, and execution of the instructions by one or more data processing apparatus can cause the one or more data processing apparatus to perform the operations of the process 500. One or more other components described herein can perform the operations of the process 500. As described above, the operations described below can be included in various implementations and in various combinations.

The computing engine obtains (505) a descriptor for a unit of work to be executed on a workload processing system, and the descriptor for the unit of work can be a workload descriptor. The system can obtain the unit of work descriptor using the techniques of operation 215 or similar operations.

In some implementations, the computing engine can obtain multiple units of work, and combine the units of work into a larger unit of work. In such cases, the units of work that are combined into a larger unit of work can be called “sub-units.” To determine which sub-units are included in a larger unit of work, sub-units of work associated with a larger unit of work can be identified in a workload descriptor. An identifier in a workload descriptor can have a structure that identifies a larger job and the sub-units that are include in the larger workload. For example, identifiers for sub-units of work of a larger job called “Job1” might be “Job1.Unit1,” “Job1.Unit2,” and so on. The workload identifier can further include an indication of the number of sub-units included in the larger job. The computing engine can identify sub-units belonging to a larger job, and aggregate the sub-units until the number of aggregate units equals the number of sub-units indicated in the workload descriptor.

The computing engine can obtain or create a workload descriptor that includes references to workload descriptors for sub-units. FIG. 5B shows such an example workload descriptor. A workload descriptor 550 for the larger job includes references 552A, 552B, 552C to three workload descriptors 555A, 555B, 5555C that describe the sub-units of work.

The computing engine can determine (510) whether the unit of work satisfies criteria. The criteria can define whether a job qualifies as a larger job that should be scheduled using the large job scheduling techniques. If the criteria are not satisfied, the computing engine can end the process of FIG. 5, and the job can be scheduled according to the process of FIG. 2. If the criteria are satisfied, the computing engine can proceed to operation 515.

The criteria used in operation 510 can be Boolean expressions of arbitrary complexity, and the criteria can be satisfied if the Boolean expression evaluates to TRUE. For example, a criterion might be satisfied if a threshold number of CPUs (e.g., 5, 10, 20, etc.) are required. Another criterion might be satisfied if a certain amount of memory (e.g., 1 terabyte) is available. In another example, a criterion can be satisfied if a particular computing resource, or group of computing resources, is available. Particular computing resources can be identified with unique resource identifiers associated with each computing resource, and as examples, a criterion might specify that a job requires “GPU-0” or “GPU-1 AND GPU-3.” As described above, computing resources can include processors (CPU, GPU, FPGA, etc.), storage systems, networking devices, and so on. In addition, criterion can specify relationships among computing resources, such as a type of storage device, or a particular storage device, attached to a server, a layout of CPU sockets, etc.

In some implementations, a criterion can be satisfied if the “area” of a job satisfies a threshold, where the area of a job can be defined as the amount of resource multiplied by the time required on the resource. In various examples, thresholds can be satisfied if the area is above a value, below a value or the same as a value, as specified by the criterion. For example, a job that requires 5 CPUs for 1 millisecond might not satisfy a criterion, but a job that requires 5 CPUs for 10 seconds might satisfy that criterion.

Further, more complex set of criteria can be used. For example, a set of criteria might be satisfied if the workload priority is above a threshold and the number of CPUs is also above a threshold.

In some implementations, the computing engine can determine whether the unit of work satisfies criteria by evaluating a machine learning model. The machine learning model can be any appropriate type of neural network or other machine learning model, and can be trained on training examples that include as features various properties of a workload. Properties of a workload can include a wide range of characteristics such as the estimated requirements for CPUs, GPUs, other processor types, network bandwidth, memory, storage, etc.; the estimated execution time; assigned categories; minimum, maximum and median wait and completion time for workloads per category; and so on. Each training example can include an outcome that indicates a job type category, where job type categories can include various indicators such as large job, short job, long job, hold job (e.g., whether to place the job in a hold state), release hold (e.g., whether to release a job from a hold state), and so on. To determine whether the criteria are satisfied, the computing engine can process an input that include the properties of the workload using the trained machine learning model to produce a prediction indicating the job type category, which can include whether the workload should be treated as, for example, a large job, i.e., whether the workload satisfies the criteria.

In response to determining that the unit of work satisfies criteria, the computing engine can assign (515) the workload descriptor for the unit of work to a “reservation” category (described further below) where it can be pulled by a first and second workload processing systems. Since not all workload processing systems will actually perform the workload, such workloads can be called “pseudo-jobs.”

Note that this process differs from the process of FIG. 2 as the workload is assigned to a reservation category that is special in that, unlike workload descriptors in other categories, multiple workload processing systems can pull the workload descriptors in reservation categories. Allowing multiple workload processing systems to pull such workloads increases the likelihood that the large job will be completed within an acceptable amount of time, as described further below.

The first and second workload processing systems can receive (517A, 517B) the workload descriptors associated with the assigned work by pulling the workload descriptor from the reservation category using the techniques of operation 240 of FIG. 2 or similar techniques.

In some implementations, upon determining that it has sufficient resource available to complete the assigned work (e.g., by comparing the requirements in the workload descriptor to the available resources), one workload processing system can perform the assigned work. Once complete, the workload processing system can provide (519) a first workload execution indicator that specifies that the workload has been completed by the workload processing system.

In some implementations, rather than providing a first workload execution indicator when a workload is complete, the workload processing systems can provide an execution indicator that includes an estimate of when the workload can be processed by the workload processing system—i.e., when the workload processing system estimates that it will have sufficient resources available. In some implementations, the workload processing system can cache the workload until it receives further information from the compute engine, as described below.

The workload processing system can provide the first workload execution indicator to the computing engine (which can be a workload processing manager system) using various techniques. As one example, the workload processing system can provide the first workload execution indicator by passing a message that includes the first workload execution indicator. In response, the computing engine can remove the workload indicator from any categories indicating that the corresponding workload requires execution. As another example, the workload processing system can provide the first workload execution indicator by removing the workload indicator from any categories indicating that the corresponding workload requires execution.

The computing engine can receive (520) the first workload execution indicator. The computing engine can use various techniques for receiving workload execution indicators. For example, the computing engine can include an API that allows a workload processing system to provide workload execution indicators and the computing engine to receive them. In another example, the computing engine can receive a message from the computing engine, and the message can contain the execution indicator. As noted above, in some implementations, the first workload indicator can be the removal of the workload descriptor from any categories indicating that the corresponding workload requires execution, and the computing engine receives the first execution indicator implicitly when the workload processing system performs the removal.

In addition, in some implementations, in response to receiving the execution indicator from at least one workload processing system, the computing engine can provide (525) an execution indicator to the second workload processing system—i.e., the workload processing system that was assigned the workload, but had not completed it or that did not have the earliest estimated execution time. The computing engine can provide the execution indicator by moving the workload descriptor to a category associated with the second workload processing system, and specifically to a category indicating that the workload need not be executed by the second workload processing system, By providing the second execution indicator, the computing engine can inform the second workload processing system that the work is no longer needed as it has been assigned to or completed by another workload processing system. The second workload processing system can receive (527) the second execution indicator and delete (529) the indicator from its list of work to be performed. The second execution indicator provided by the computing system can be the first execution indicator received from the workload processing system, or it can be an execution indicator generated by the computing system. The computing engine can provide the execution indicator by moving the workload among categories (as described above), calling an API provided by the second workload processing system and/or by providing a message to the second workload processing system.

As described above, operations 525, 527 and 529 are included only in some implementations. In implementations in which workload descriptors for large jobs are added to reservation categories, and workload processing systems initially provide estimates of when the workload can be processed by the workload processing system, workload processing systems not selected to perform the work will not have initiated execution, and therefore do not require a notification to cease work.

In implementations in which the first execution indicator includes an estimate of when the workload can be processed, the computing engine can determine the workload processing system that can execute the workload at the earliest time by comparing the estimates in the execution indicators. The computing engine can provide (530) a third execution indicator to the workload processing system that has been determined to have the earliest estimate, and the third execution indicator can specify that the workload processing system should proceed to execute the workload when the resources become available.

The computing engine can provide the execution indicator using various techniques. For example, the computing engine can place workload descriptor in a category associated with the workload processing system that will perform the work. In another example, the computing engine can provide a message to the selected workload processing system. In response to receiving (535) the third workload indicator (e.g., by reading the workload descriptor from the category or by receiving a message), the first workload processing system can execute the workload.

Returning to FIG. 2, in some implementations, the system assigns (225) a priority indicator. The priority indicator can be assigned based on static and/or dynamic criteria. Static criteria reflect properties of a workload that do not change. Examples can include an affiliation of the workload, the time of submission, the expected resources to be consumed, and so on. The affiliation of a workload can include the owner of the workload, the submitter, the organization (e.g., team, department, unit, division, etc., or any combination thereof) of the owner and/or the submitter, and so on. Dynamic criteria can reflect properties of a workload that can change. Examples can include the number of workloads submitted by a user or by an organization, the amount of resources consumed, as measured over a configured period of time, by the workload submitted by a user or by an organization, the amount of resources consumed by the workload submitted by a user or by an organization as compared to an allocation or quota assigned to the user or organization, the age of the workload (e.g., the duration between the time at which the workload was submitted and the time at which the priority is being determined), the number of workloads a submitter or organization currently has executing, the amount of resources consumed by workloads a submitter or organization currently has executing, and so on. In addition, workload consumption can be determined using a decay function (e.g., exponential decay) such that more recent use is considered more heavily than less recent use.

In some implementations, priority is assigned based on rules. A rule can include a predicate and a resulting priority value. Predicates can relate to static or dynamic criteria and can be Boolean expressions of arbitrary complexity. For example, a predicate can indicate whether the workload owner is a company's Chief Information Officer, which often correlates with higher priorities. In another example, a predicate can test whether the workload owner has submitted more than a threshold number of workloads, which often correlates with a lower priority.

In some implementations, the system can determine a priority value using job requirements. In some implementations, the system can assign higher priority to jobs that are predicted to consume sparse or valuable resources such as software licenses or special-purpose computing hardware. Assigning higher priority to such jobs encourages efficient use of sparse or relatively valuable resources.

In some implementations, the system can assign a priority based at least in part on the amount of time a job has been pending. For example, the system can assign higher priorities to job that have been pending the longest, or all jobs that have been pending for over a threshold “wait” time.

The priority value can be a value that indicates priority or a value that is used to compute a priority. Values indicating priority can be tokens such as “high,” “medium,” and “low” that are recognized by a cluster manager engine (as described further below). Values indicating priority can also have an inherent order such as integers (e.g., integers in the range 1 to 10, with 10 indicating the highest priority) or characters (‘a’ to ‘z,’ with ‘z’ indicating the highest priority).

In some cases, multiple rules might evaluate to TRUE. In such cases, the system can assign priority using a “first match” rule in which the system assigns the priority value from the first rule for which the predicate is satisfied.

In some implementations, the system can compute a priority from multiple priority values. For example, the computation can include the priority values from every rule that evaluates to TRUE, and the system can compute a composite priority from such priority values. Composite priority values can be computed using various techniques such as using a mathematical sum, an average, a weighted average (i.e., component priority values can be weighted differently), a median value, a modal value, and so on.

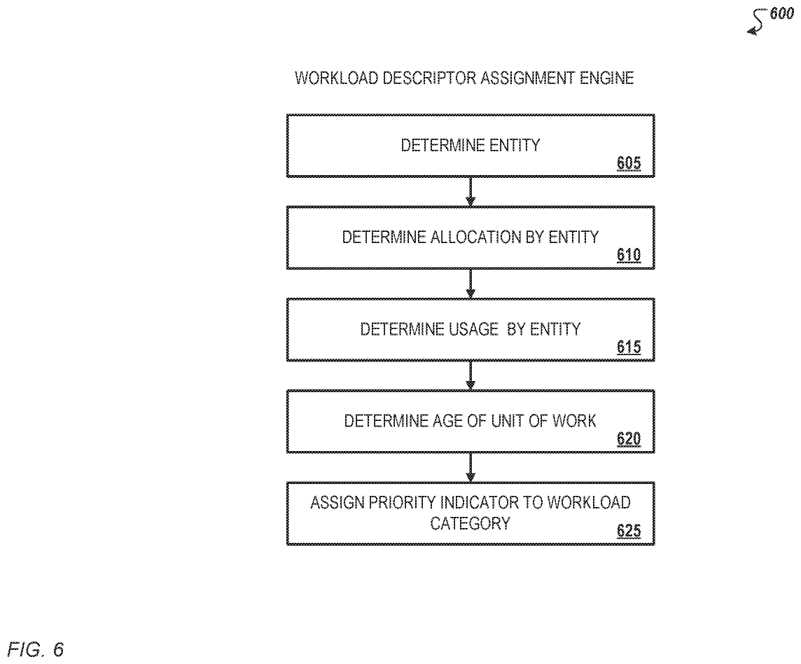

FIG. 6 shows a process for assigning priority. For convenience, the process 600 will be described as being performed by a workload processing manager system, e.g., the workload processing manager system 110 of FIG. 1, appropriately programmed to perform the process. Operations of the process 600 can also be implemented as instructions stored on one or more computer readable media, which may be non-transitory, and execution of the instructions by one or more data processing apparatus can cause the one or more data processing apparatus to perform the operations of the process 600. One or more other components described herein can perform the operations of the process 600. As described above, the operations described below can be included in various implementations and in various combinations.

The workload descriptor assignment engine can determine (605) an entity associated with the workload category. In some implementations, an entity can describe a role associated with the submitter of a workload. For example, an entity can be the submitter, the organization of the submitter, the owner of the workload, the organization of the owner of the workload, and so on. As described above, entity information can be associated with the workload descriptors and workload descriptors can be assigned to workload categories. Therefore, the workload descriptor assignment engine can determine the entity of a workload category from the information associated with the workload category.

The workload descriptor assignment engine can determine (610) an allocation by entity. An entity's allocation can be provided by a system administrator to the workload descriptor assignment engine within a workload processor manager system. For example, an administrator can enter allocations in a file that is read by the workload processor manager system. In another example, the workload processor manager system can provide user interface presentation data to system administrator. When rendered by the administrator's computing device, the user interface presentation data can enable the administrator to provide allocation information to the workload processor manager system.

The workload descriptor assignment engine can determine (615) usage by entity. In some implementations, a workload processing system can monitor activity of the computing resources managed by the workload processing system and provide to the workload descriptor assignment engine information describing resource usage. Such information can include the amount of resource consumed, the entity that provided the workload and other conventional computing system monitoring information. The resources consumed can be metrics that summarize overall usage, or detailed information about resources consumed, such as processing cycles, storage, memory and network. The workload processing system can include an API through which the workload descriptor assignment engine can retrieve the information.

The workload descriptor assignment engine can determine (620) an age of work. As noted above, workload descriptors can include an indication of submission time. To determine the age of the work, the workload descriptor assignment engine can compare the submission time to the current time. In addition, the workload descriptor assignment engine can determine various age metrics. For example, such metrics can be determined from the workload descriptor in a workload category that the highest age, the mean age for workload descriptors in a workload category, the median age for workload descriptors in a workload category, and so on.

The workload descriptor assignment engine can assign (625) a priority indicator to the workload category. The workload descriptor assignment engine can determine a priority at least in part using the allocation by entity, usage by entity and/or the age of the work. As described above, factors influencing a priority can be combined using various techniques.

Once the workload descriptor assignment engine has determined a priority, the workload descriptor assignment engine can assign a priority indicator reflecting the priority by associating the priority indicator with the workload category. For example, the workload descriptor assignment engine can store the priority indicator in the fingerprint associated with the workload category.

Returning to FIG. 2, a cluster manager engine determines (230) the availability of computing resources for the workload processor(s) managed by the cluster manager engine. In some implementations, the cluster manager engine can query a first API provided by a workload processor to determine a measure of the total resources of a workload processor and query a second API to determine a measure of the resources that are currently in use. The cluster manager engine can determine the available resources by subtracting a measure of resources currently in use from a measure of the total resources. To avoid repeated calls to the first API, the cluster manager engine can store the measure of total resources for later use. In some implementations, the cluster manager engine can query an API provided by a workload processor that returns a measure of the available resources.

The cluster manager engine selects (240) a descriptor from a workload category. The cluster manager can use a two-step process: (i) select a workload category, and (ii) select a descriptor from the selected workload category.

To select a workload category, the cluster manger can determine whether the resources in the cluster it manages satisfy the category criteria for one or more categories. The cluster manager engine can determine the resources present in the cluster from the information included in a resource descriptor provided by the cluster, as described above.

In some implementations, the cluster manager can determine a workload category appropriate for the resources present in the cluster by determining whether the resources present in the cluster satisfy the category criteria associated with the categories. If the category criteria are satisfied, the cluster manager can select the category. To make this determination, the cluster manager can retrieve the category criteria associated with a first category (e.g., by retrieving the first category from a workload repository), then determine whether the resources for the cluster (as specified by the resource descriptor) satisfy the category criteria. For example, if the category criteria require a GPU, the cluster manager can determine from the resource descriptor whether the cluster contains a GPU.

In some implementations, the cluster manager can determine instantaneous properties of the cluster it manages, and use those instantaneous properties to determine whether the cluster satisfies the category criteria, as described in reference to operation 230. The cluster manager can send a message to the cluster requesting a listing of resources that are currently available. The cluster can respond with a resource descriptor that includes an element that indicates that the resource descriptor specifies currently available resources. The cluster manager can then determine whether the available resources satisfy the category criteria. Such technique can further improve efficiency in the case where a cluster can exhaust a resource, which can delay processing. For example, if a cluster contains a single GPU, and that GPU is occupied, then any workload requiring a GPU will be delayed until the GPU is freed. Matching on currently available resources eliminates such resource mismatches.

In some implementations, the cluster manager engine can evaluate the priority assigned to workload categories and base the selected category at least in part on the priority. For example, the cluster manager engine can determine the categories that satisfy the category criteria, then select the workload category with the highest priority. In another example, the cluster manager engine can determine the categories that satisfy the category criteria, then select a workload category that satisfies a threshold priority level.

If the cluster manager engine determines that multiple category criteria are satisfied, the system can use a secondary selection techniques to select a category. In some implementations, the cluster manager engine can evaluate configured rules to select the category. For example, a rule can specify that the cluster manager engine will select the category that has assigned the highest priority. In some implementations, the cluster manager engine can select the first category for which the category criteria are satisfied. Other secondary selection techniques can also be used.

Once the cluster manager has determined a resource category, it can select a workload descriptor from the category. In some implementations, the cluster manager can select the first workload descriptor in the category. For example, if the workload descriptors are stored in a queue (or alternative FIFO data structure), the system can select the workload descriptor at the head of the queue.

The cluster manager engine determines (250) the unit of work associated with the workload descriptor. In some implementations, the workload descriptor includes the location of the unit of work (e.g., the location of the executable(s)), as described above. In some implementations, the workload descriptor includes a reference to a storage location that includes the unit of work, and the system uses the reference to locate the unit of work.

The cluster manager engine assigns (260) the unit of work to the cluster managed by the cluster manager engine. Techniques for assigning the unit of work will depend on the automation software system that manages the cluster. Such systems typically provide an API through which workloads can be provided to the system, and the cluster manager engine can use the API to submit the workload.

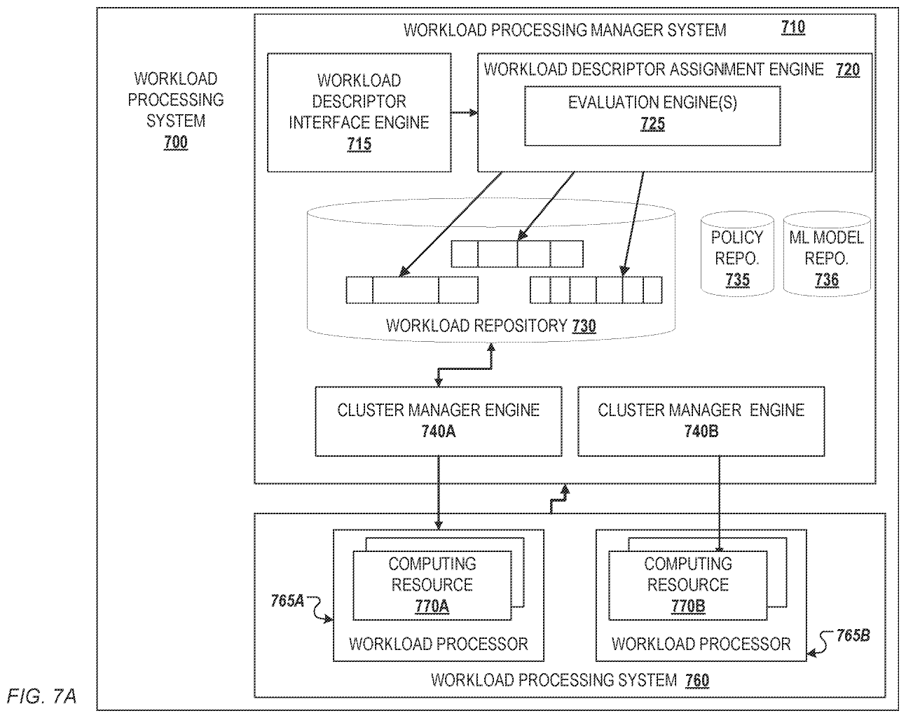

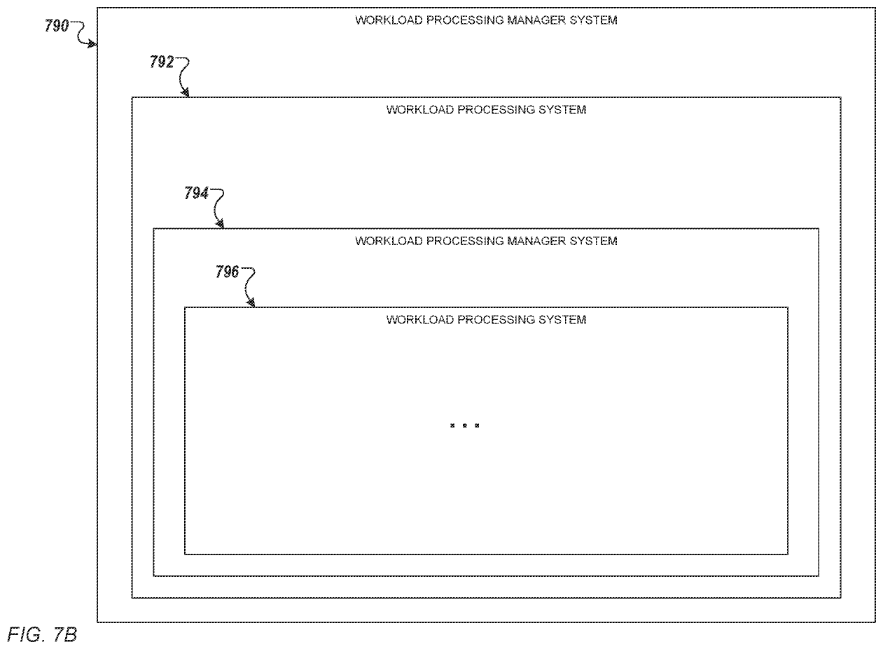

To manage incoming work, in some implementations, a workload processing system can include a workload processing manager system, e.g., the workload processing manager system 110 of FIG. 1. FIG. 7A shows an example workload processing system 700 that includes a workload processing manager system 710.

The elements of the workload processing manager 710 in the workload processing system 700 can include components that are the same as, or similar to, the components of the workload processing manager 110 of FIG. 1. Specifically, the workload processing system 700 can include a workload processing manager system 710 and a workload processing system 760. The workload processing manager system 710 can include a workload descriptor interface engine 715, a workload descriptor assignment engine 720, which can include evaluation engines 725, a workload repository 730, a policy repository 735, a machine learning model repository 736, and cluster manager engines 740A, 740B.

The workload processing system 760 can include workload processors 765A, 765B, which can each include computing resources 770A, 770B. The workload processors 765A, 765B can be subsets of the workload processors of the larger workload processor manager system (e.g., the workload processor manager system 110 of FIG. 1) that contains the workload processing system 700. For example, if the larger workload processor manager system manages a workload processor 700 that includes two racks of server blades, one computing resource 770A can be the first rack and a second computing resource 770B can be the second rack.

In some implementations, the workload processing system 760 can itself include a workload processing manager system, providing a fractal-like structure. FIG. 7B shows an example of a workload processing manager system 790 that contains embedded workload processing manager systems. The outermost workload processing manager system 790 includes a workload processing system 792, which itself includes a workload processing manager system 794. The workload processing manager system 794 includes a workload processing system 796, and the structure can be repeated to any number of levels. Such a fractal structure provides the benefits of the scheduling techniques described in this specification within a workload processing system (e.g., workload processing system 792).

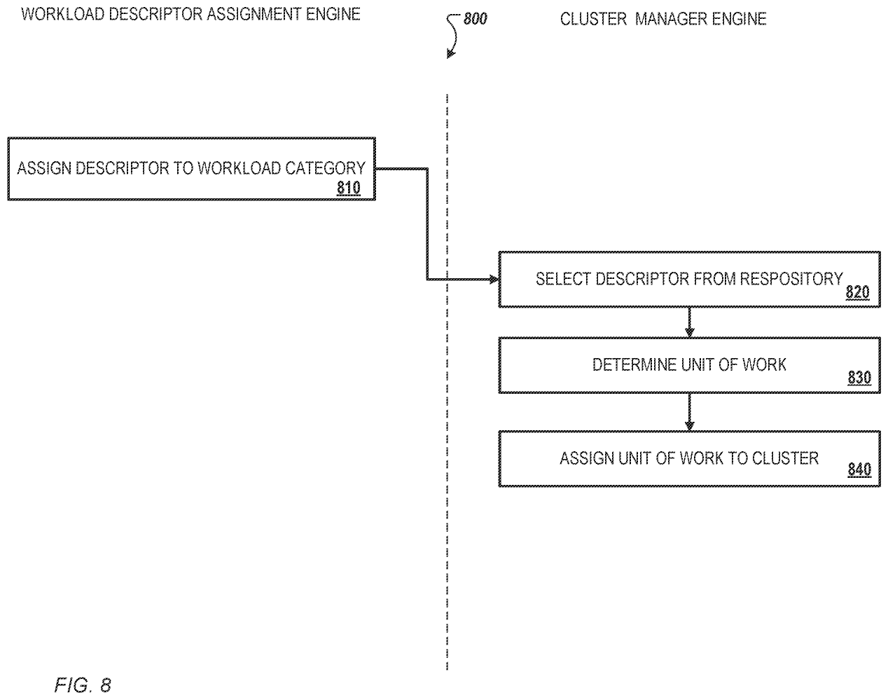

FIG. 8 shows a process for liquid workload scheduling within a workload processing system. For convenience, the process 800 will be described as being performed by a workload processing system, e.g., the workload processing system 700 of FIG. 7A, appropriately programmed to perform the process. Operations of the process 800 can also be implemented as instructions stored on one or more computer readable media, which may be non-transitory, and execution of the instructions by one or more data processing apparatus can cause the one or more data processing apparatus to perform the operations of the process 800. One or more other components described herein can perform the operations of the process 800.

The system assigns (810) the workload descriptor to a workload category using the operations 220 of FIG. 2 or similar operations.

The cluster manager engine selects (820) a descriptor from a workload category. The cluster manager engine can use the operations 240 of FIG. 2, or similar operations. For example, the cluster manager can use a two-step process, (i) select a workload category, and (ii) select a descriptor from the selected workload category, as described in reference to FIG. 2.

The cluster manager engine determines (830) the unit of work associated with the workload descriptor. The cluster manager engine can use the operations 250 of FIG. 2, or similar operations.

The cluster manager engine assigns (840) the unit of work to the cluster managed by the cluster manager engine. The cluster manager engine can use the operations 260 of FIG. 2, or similar operations, causing the cluster (which can be a computing engine) to execute the unit of work. The arrangement of workload processor manager systems included in workload processing system can results in a hierarchical organization of workload categories. For example, workload categories stored in a workload repository in the main workload processing system (e.g., the workload processing system 110 of FIG. 1) can be viewed as being at the top of a hierarchy, and the workload categories stored in a workload repository in a workload processing system within the main workload processing system can be viewed as being at a lower level of the hierarchy.

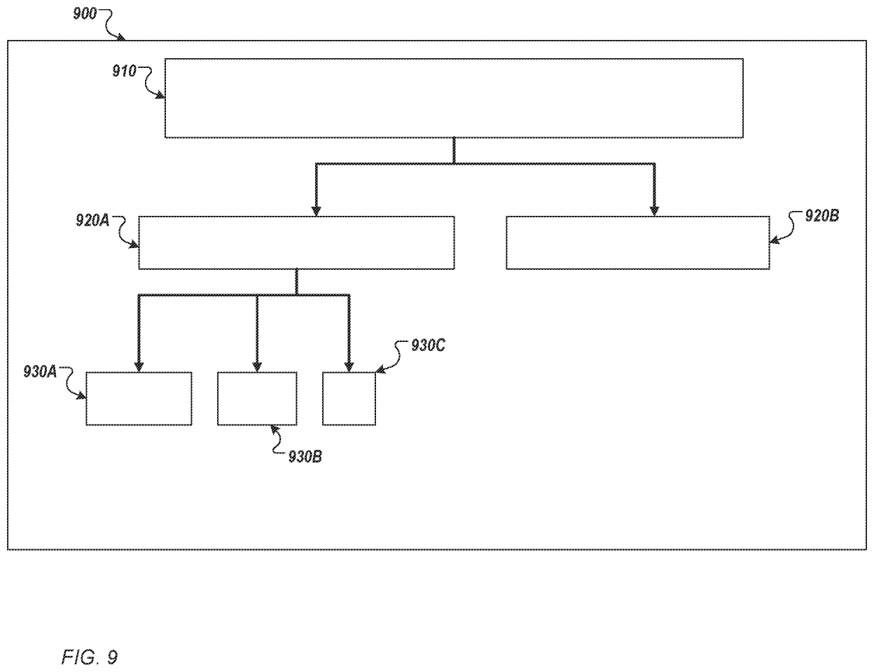

FIG. 9 shows an example hierarchical collection 900 of workload categories. The top-level category 910 can contain descriptors for the entire workload set, or for some subset of the workload. One level below, two workload categories 920A, 920B can each contain a subset of the descriptors from the top level category 910. Another level below, three workload categories 930A, 930B, 930C can each contain a subset of the descriptors from workload category 920A. The hierarchy 900 can contain an arbitrary number of levels.

The hierarchy can be based on any property of the workload. For example, each level can indicate whether a workload requires a particular computing resource. The top level 910 of the hierarchy 900 can contain all workload descriptors. At the level below, one category 920A can contain workload descriptors for workloads that require a GPU, and a second category 920B can contain workload descriptors that do not require a GPU. At the level below, a first category 930A can contain workload descriptors that require a GPU and only one CPU; a second category 930B can contain workload descriptors that require a GPU and two to five CPUs; and a category 930C can contain workload descriptors that require a GPU and over five CPUs.

In another example, the refinement from one hierarchy level to another hierarchy level can be based on affiliation (described above). In addition, refinements from multiple levels can be based on different aspects of affiliations. For example, a second level of the hierarchy can be based on the organization of owner of a workload, and the third level (the level below the second level) can be the owner of the workload.

The various criteria used to refine the hierarchy can be intermixed arbitrarily and can be based on a wide variety of factors, including any element of a workload descriptor, among other factors. For example, a level below the top level can indicate whether a GPU is needed, and the level below can indicate an affiliation.

FIG. 3 shows a process for iteratively applying policies to workload descriptors. For convenience, the process 300 will be described as being performed by a workload processing manager system, e.g., the workload processing manager system 110 of FIG. 1, appropriately programmed to perform the process. Operations of the process 300 can also be implemented as instructions stored on one or more computer readable media which may be non-transitory, and execution of the instructions by one or more data processing apparatus can cause the one or more data processing apparatus to perform the operations of the process 300. One or more other components described herein can perform the operations of the process 300.

As described in reference to operation 220 of FIG. 2, the system assigns workload descriptors to workload categories according to characteristics of the workload, characteristics of the categories and policies. (As noted above, in some implementations, machine learning models are used instead of, or in addition to, policies.) However, it can be technically beneficial to provide further ordering by using hierarchical categories. For example, two workloads might both be designated to require identical resources, but one workload might be more urgent. In such cases, the computing system's resources are used most efficiently if the more urgent of the jobs executed first. To accomplish such ordering, the system can iteratively apply policies to the workload categories, assigning the workload descriptors to more specific categories at each iteration.

In addition, some submitted workloads might not be ready to execute, and reserving cluster resources for such jobs would result in an inefficient use of such resources. Therefore, it can be technically advantageous to assign workload descriptors associated with workloads that are not ready to execute to workload categories designated to hold such workloads until they are ready to execute.

To achieve these advantages, the system can select (310) a workload category. As described above, a workload repository can contain a data structure that includes references to the workload categories. The system can access that data structure, and determine the workload categories from the data structure. For example, if the data structure is an array, the system can select the first element of the array, and from the reference in the array, determine the workload category.

The system selects a workload descriptor (320) from the category. As described above, workload categories can be stored in a conventional data structure that contains workload descriptors or references to workload descriptors. In some implementations, the workload descriptors or references to workload descriptors are stored in a read-only, FIFO data structure. In some implementations, the system can store workload descriptors or references to workload descriptors for a category in an array and read the items sequentially. If the items stored are references to workload descriptors, the system can select the reference to the workload descriptor in FIFO order, and use the reference to determine the workload descriptor.

The system determines whether the workload descriptor represents a workload that is ready to execute (330). As described above, in some implementations, the workload descriptor contains an element that specifies whether a workload is ready to execute. In such cases, the system makes the determination based on that element.

In some implementations, the workload descriptor contains an element that specifies other workloads that must complete before the workload associated with this descriptor can complete—that is, this workload depends on one or more other workloads. In such cases, the system can determine whether all such workloads have completed. If so, the workload associated with the workload descriptor is ready to execute; otherwise, the workload is not ready to execute.

In response to determining (330) that the workload descriptor is ready to execute, the system proceeds to operation 340; in response to determining (330) that the workload descriptor is not ready to execute, the system proceeds to operation 350.

The system assigns (340) the descriptor to a ready-to-execute workload category. In some implementations, the system can move the workload descriptor from the category selected in operation 310 and to category with identical categories criteria plus a criterion that specifies that the workload is ready to execute. If such a category does not exist, the system can create one.

The system assigns (350) the descriptor to a not-ready-to-execute workload category. In some implementations, the system can move the workload descriptor from the category selected in operation 310 and to category with identical categories criteria plus a criterion that specifies that the workload is not ready to execute. If such a category does not exist, the system can create one.

If the system determines (360) that there are additional workload descriptors to evaluate in the category, the system returns to operation 320. If the system determines (360) that there are no additional workload descriptors to evaluate, the system proceeds to operation 362.

The system can select a category (362) and select (365) a workload descriptor from the category using operations analogous to operations 310 and 320. In this example, the category can be the ready-to-execute category described above.

The system determines (370) whether the workload descriptor represents a workload that is high priority. As described above, in some implementations, the workload descriptor contains an element that specifies whether a workload is high priority. In such cases, the system makes the determination based on that element.

In response to determining (370) that the workload descriptor is high priority, the system proceeds to operation 375; in response to determining (370) that the workload descriptor is normal priority, the system proceeds to operation 377.

The system assigns (375) the descriptor to a high priority workload category. In some implementations, the system can move the workload descriptor from the category selected in operation 362 and to category with identical categories criteria plus a criterion that specifies that the workload is high priority. If such a category does not exist, the system can create one.

The system assigns (377) the descriptor to a normal priority workload category. In some implementations, the system can move the workload descriptor from the category selected in operation 362 and to category with identical categories criteria plus a criterion that specifies that the workload is normal priority. If such a category does not exist, the system can create one.

If the system determines (380) that there are additional workload descriptors to evaluate in the category, the system returns to operation 365. If the system determines (380) that there are no additional workload descriptors to evaluate, the system proceeds to operation 399 and terminates.

By iteratively applying policies to the workload descriptors, the system can assign the workload descriptors to workload categories that are increasingly specific. In the example of FIG. 3, the system first assigns the workload descriptors to categories based on whether the workloads corresponding to the workload descriptors are ready to execute, then assigns the workload descriptors to more specific categories based on whether the workload descriptors represent high-priority or normal priority workload. In this example, workload descriptors are assigned to workload categories corresponding to: {ready to execute, high priority}, {ready to execute, normal priority}, {not ready to execute, high priority} and {not ready to execute, normal priority}.

These two examples are non-limiting, and there is a wide range of possible policies. In various implementations, the system can order the workloads based on ordering criteria applied to the elements of the workload descriptor For example, ordering criteria can specify that the system can order the work based on estimated run time, e.g., shortest job first. In this example, jobs with an estimated run time below a threshold can be assigned to one category, and jobs with an estimated run time equal to or above the threshold can be assigned to a different category. Naturally, by iteratively applying policies, the system can order the workloads based on multiple ordering criteria creating a hierarchy of arbitrary depth. For example, the system can order the workloads based on shortest job first, then based on priority.

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 470. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method comprising:
obtaining, by a first computing engine, a descriptor for a unit of work to be executed on a workload processing system, wherein:
(i) the first computing engine manages the workload processing system that comprises two or more workload processors, and
(ii) a first workload processor of the workload processing system is managed by a second computing engine;
assigning, by the first computing engine, the descriptor to a first workload category of a plurality of workload categories based at least in part on a resource requirement fingerprint that characterizes the unit of work;
selecting, by the second computing engine, the descriptor from the first workload category based at least in part on:
(i) the resource requirement fingerprint of the descriptor, and
(ii) available resources within the first workload processor; and
determining, by the second computing engine, the unit of work associated with the descriptor; and
causing, by the second computing engine, the first workload processor to execute the unit of work.

2. The method of claim 1, further comprising:
assigning, to the first workload category, a priority indicator, and
wherein the selecting is based at least in part on the priority indicator.

3. The method of claim 2, wherein the first workload category represents an affiliation.

4. The method of claim 2, wherein assigning the priority indicator comprises determining one or more of an allocation by an entity, an actual use by the entity or an age of the unit of work.

5. The method of claim 1, further comprising:
obtaining, by the first computing engine, a second job descriptor for a second unit of work to be executed on a workload processing system;
in response to determining, by the first computing engine, that the second unit of work satisfies criteria, assigning the second job descriptor to a first workload processing system and to a second workload processing system concurrently; and
selecting, by the first computing engine, the first workload processing system to process the second unit of work; and
providing, by the first computing engine, a third execution indicator to the first workload processing system to cause the first workload processing system to execute the second unit of work.

6. The method of claim 5, wherein the first workload processing system transmits a first execution indicator to the first computing engine to indicate an availability to execute the second unit of work.

7. The method of claim 5, further comprising:
in response to receiving, by the first computing engine and from the first workload processing system, a first execution indictor, delivering, by the first computing engine to the second workload processing system, a second execution indicator.

8. The method of claim 7, wherein the first execution indicator and the second execution indicator are the same execution indicator.

9. The method of claim 5, wherein the first computing engine generates the second unit of work by combining a plurality of sub-units of work.

10. The method of claim 1, further comprising:
assigning, by the second computing engine, the descriptor to a second workload category of a second plurality of workload categories based at least in part on a resource requirement fingerprint that characterizes the unit of work;
selecting, by a third computing engine, the descriptor from the second workload category based at least in part on:
(i) the resource requirement fingerprint of the descriptor, and
(ii) available resources within a second workload processor that is managed by the second computing engine; and
determining, by the second computing engine, the unit of work associated with the descriptor; and
causing, by the second computing engine, the second workload processor to execute the unit of work.

11. The method of claim 10, wherein the first workload category and the second workload category are arranged hierarchically.

12. The method of claim 1 further comprising: executing, by the first workload processor, the unit of work.

13. The method of claim 1 wherein the assigning comprises:
determining a first workload policy relevant to the unit of work;
evaluating the first workload policy to produce a first policy result; and
assigning the descriptor associated with the unit of work to the first workload category of the plurality of workload categories based at least in part on the first policy result.

14. The method of claim 13 further comprising:
evaluating a second workload policy to produce a second policy result; and
assigning the descriptor associated with the unit of work to the first workload category of the plurality of workload categories based at least in part on the first policy result and the second policy result.

15. The method of claim 1 further comprising:
determining, by the first computing engine, descriptors assigned to the first workload category;
determining, by the first computing engine, that a descriptor in the descriptors is associated with a unit of work that is not ready to execute; and
assigning the descriptor to a third workload category that stores descriptors associated with units of work that are not ready to execute.

16. The method of claim 1 where the resource requirement fingerprint comprises one or more of: number of CPUs needed, memory requirement, storage requirement, number of GPUs needed or network bandwidth.

17. The method of claim 1 wherein a second workload processor of the workload processing system is managed by a third computing engine wherein the second computing engine differs from the third computing engine.

18. The method of claim 1 wherein the assigning comprises:
processing an input comprising features that include at least a subset of values in the descriptor using a machine learning model that is configured to generate category predictions; and
assigning the descriptor to the first workload category of the plurality of workload categories based at least in part on a category prediction of the category predictions.

19. A system comprising one or more computers and one or more storage devices storing instructions that when executed by the one or more computers cause the one or more computers to perform operations comprising:
obtaining, by a first computing engine, a descriptor for a unit of work to be executed on a workload processing system, wherein:
(i) the first computing engine manages the workload processing system that comprises two or more workload processors, and
(ii) a first workload processor of the workload processing system is managed by a second computing engine;
assigning, by the first computing engine, the descriptor to a first workload category of a plurality of workload categories based at least in part on a resource requirement fingerprint that characterizes the unit of work;
selecting, by the second computing engine, the descriptor from the first workload category based at least in part on:
(i) the resource requirement fingerprint of the descriptor, and
(ii) available resources within the first workload processor; and
determining, by the second computing engine, the unit of work associated with the descriptor; and
causing, by the second computing engine, the first workload processor to execute the unit of work.

20. One or more non-transitory computer-readable storage media storing instructions that when executed by one or more computers cause the one or more computers to perform operations comprising:
obtaining, by a first computing engine, a descriptor for a unit of work to be executed on a workload processing system, wherein:
(i) the first computing engine manages the workload processing system that comprises two or more workload processors, and
(ii) a first workload processor of the workload processing system is managed by a second computing engine;
assigning, by the first computing engine, the descriptor to a first workload category of a plurality of workload categories based at least in part on a resource requirement fingerprint that characterizes the unit of work;
selecting, by the second computing engine, the descriptor from the first workload category based at least in part on:
(i) the resource requirement fingerprint of the descriptor, and
(ii) available resources within the first workload processor; and
determining, by the second computing engine, the unit of work associated with the descriptor; and
causing, by the second computing engine, the first workload processor to execute the unit of work.
